(19) United States
(12) Patent Application Publication
(10) Pub. No.: US 2002/0163262 A1
(43) Pub. Date: Nov. 7, 2002

(54) High performance stator device

(76) Inventor: Chun-Pu Hsu, Taipei Hsien (TW)

Correspondence Address: RABIN & CHAMPAGNE, PC, 1101 14TH STREET, NW, SUITE 500, WASHINGTON, DC, 20005, US

(21) Appl. No.: 09/848,415

(22) Filed: May 4, 2001

(51) Int. Cl. H02K 11/00; H02K 3/00

(52) U.S. Cl. 310/68 R; 310/254

(57) ABSTRACT

A high performance stator device is used to a stator device of an electromotive machine or a generator. The stator portion of an electromotive machine or a generator is provided with a plurality of coils. The wire head and wire tail of each coil are independent. Various coils are connected through a switch control system. Then the connected stator has a single phases or three phases network forms. Through the control of a switch control system, the numbers of windings of the stator portion can have various forms. The change of the number of windings may change the inverse electromotive force K_{E} and twisting force constant K_{T}. In the low, middle, and high operation ranges, the electromotive machine or generator may retain average high operation efficiency. Moreover, the K_{T} is increased greatly, since T=K_{T}·I, so the output twisting force has various forms.

### FIELD OF THE INVENTION

The present invention relates to a high performance stator device, wherein the inverse electromotive force K_{E} and twisting force constant K_{E} can be changed by the present invention easily. Therefore, the inverse electromotive force K_{E} and twisting force constant K_{T} in the same electromotive machine or generator can be changed as the requirement of a load. Similarly, for a generator in operation, the inverse electromotive force K_{E} can be changed according to the requirement of output voltage of the generator. It can be described by the following equation:

E=K_{E}·Ω

K_{E}=D·B·L·Z/2

T=K_{T}·Iₐ

K_{T}=D·B·L·Z/2

E is the voltage of inverse electromotive force vertical (Volt)

T is the output twisting force (N-m)

K_{E} is an inverse electromotive force constant

K_{T} is an twisting force constant

Ω is the rotary speed of an armature (red/sec)

Iₐ is the current of armature (Ampere)

B is magnetic flux density of air gap (Gauss)

D is an outer diameter of an armature (cm)

L is stacking thickness (cm)

Z is the total conductor number

From above equation, it is known the inverse electromotive force K_{E} is equal to the twisting force constant K_{T}. Furthermore, the total conductor number Z is positive proportional to the K_{E} and K_{T}. Therefore, as the total conductor number Z in the same electromotive machine or generator changed, then the inverse electromotive force K_{E} and twisting force constant K_{T} changed therewith.

### BACKGROUND OF THE INVENTION

From the equation of T=Kₜ·Iₐ, it is known that the twisting force T is resulted from the twisting force constant K_{T} multiplied by amature current Iₐ. However, the coils of the stator of the conventional electromotive machine is formed by a single winding of excited coil. Therefore, the twisting force constant is a constant value. Therefore, if it is desired to changed the twisting force T of an electromotive machine, it must change Iₐ. A larger T is acquired from a larger Iₐ. But a too larger Iₐ is not beneficial to the efficiency of an electromotive machine.

P=I²·R

P: power consumption in the coil of an electromotive machine.

I: armature current

R: impedance of a coil

Therefore, it is knows that if the current is enlarged, then the power will become a square value so that the heat resistance of the coil is increased. Thus, the temperature of the electromotive machine is incremented to deteriorate the efficiency of the electromotive machine. Referring to FIG. 14D, in the output operational efficiency curve of the stator portion with the twisting force constant K_{T}, it is appreciated that the preferred operation range of the electromotive machine is from 2.0 to 3.0 time of rpm operation.

Meanwhile, since E=K_{E}.·Ω, if the generator is in a constant opertion speed, since stator portion is a single winding coil, the inverse electromotive force KE must be fixed, and thus, the inverse electromotive voltage E is retained in a fixed value, can't be changed.

As the operation efficiency of an electromotive machine or a generator from the low speed to the higher speed is not in a fixed value (Referring to FIG. 14D), even there is a high operation efficiency EFF, since the speed of the electromotive machine or generator must be changed in the low, middle or high operation speed due to the requirement of operation, it is obvious that the electromotive machine or generator must have EFFs of low, middle and high efficiency with the change of the rotary speed.

### SUMMARY OF THE INVENTION

Since the prior art stator portion is a single winding coil, the inverse electromotive force K_{E} and twisting force constant K_{T} must be fixed. Therefore, the preferred operation range is finite (referring FIG. 14D), in the present invention, the area of wire groove in the stator portion is enlarged properly (FIGS. 1B and 1D shows an example that the wire grooves of the inner and outer stator portions are not be enlarged). The stator portion 61 has a general wire groove space 611, stator tooth portion 612, and stator ring portion 613. With reference to FIGS. 1C and 1E, the wire grooves of the inner and outer stator portions are not be enlarged as in the the present invention, the stator portion 61 has a deeper wire groove space 614, a prolonged stator tooth portion 615 and a stator ring portion 616. It can be installed with a plurality of coils with different number of windings. This stator is controlled by a management control unit of a control system. The numbers of windings of the stator tooth portion can be varied. The change of the number of windings will change the inverse electromotive force K_{E} and twisting force constant K_{T} of an electromotive machine or a generator.

The proper change of the inverse electromotive force K_{E} and twisting force constant K_{T} will cause the change of the working range. Therefore, as shown in the FIGS. 8A, 8B, 13A and 13B, the stator has a plurality of twisting force constant K_{T}s which covers the ranges of the lower, middle and high operation rotary ranges. Furthermore, as shown in FIG. 1A, a control system is illustrated, the rotary speed sensor 512, operation rotary speed detector 54 and the operational current sensor 515 output signals, then the signals 411 are inputted to the management control unit of a control system. Therefore, the twisting force constant K_{T}s of the electromotive machine or generator (referring to FIGS. 5A, 5B, 13A and 13B) of the electromotive machine or generator generate a wider operation rotary speed range with a high efficiency EFF. FIGS. 5A, 5B show the switching lines 414 of the control system.

Moreover, since the electromotive machine may retain with a high efficiency power out in the low and middle operational rotary speed. It represents that if the electromotive machine has a high operational twisting force in low and middle rotary speed. This can be described by the following equations:

T=P/n, T=K_{T}·I, and E=K_{E}.·Ω

T: motor output twisting force,

P: motor output power

n: motor rotary speed

In the present invention, the electromotive machine and generator can have a higher operation efficiency and can change the inverse electromotive force KE and twisting force constant KT quickly. Since the twisting force constant is positive proportional to the motor output power or K_{T}, the twisting force constant K_{T} can be in an average level or a high level inverse electromotive voltage E can be acquired despite that it is in low or middle operation range.

The various objects and advantages of the present invention will be more readily understood from the following detailed description when read in conjunction with the appended drawing.

### BRIEF DESCRIPTION OF THE DRAWINGS

FIG. 1A shows the circuit connection of two Y type coils in the first embodiment of the present invention.

FIG. 1B is a schematic view showing the conventional wire groove of the inner stator portion.

FIG. IC is a schematic view showing that the wire groove of the inner stator portion of the present invention has a larger depth.

FIG. 1D is a schematic view showing the conventional wire groove of the outer stator portion.

FIG. 1E is a schematic view showing the enlargement of the wire groove of the outer stator portion in the present invention.

FIG. 2A is a schematic view of the first embodiment in the present invention, wherein two Y type coils are switched to a stator coil L1 having a smaller number of windings by switches.

FIG. 2B is an operational efficiency curve of the network with less number of windings in the stator coil L1 of FIG. 2A.

FIG. 3A is a schematic view in the first embodiment of the present invention, wherein two Y type coils are switched to a stator coil L2 with much number of windings.

FIG. 3B shows an operation efficiency curve of the network having number of windings more than that shows in FIG. 3A.

FIG. 4A is a schematic view in the first embodiment of the present invention, wherein two Y type coils are switched to a serial connecting loop with stator coil having the number of windings (L1+L2).

FIG. 4B shows an operation efficiency curve of the network having number of windings (L1+L2) of FIG. 4A to be a maximum number.

FIGS. 5A and 5B shows the operation efficiency curve in the first embodiment of the present invention, wherein three twisting force constant K_{T} are combined so as to have a wider operation range.

FIG. 6A is a schematic view of the second embodiment in the present invention, wherein three Y type coils are switched to a stator coil L1 having a smallest number of windings by switches.

FIG. 6B is an operational efficiency curve of the network with less number of windings in the stator coil L1 of FIG. 6A.

FIG. 7A is a schematic view of the second embodiment in the present invention, wherein three Y type coils are switched to a stator coil L2 having a second smaller (next to the smallest) number of windings by switches.

FIG. 7B is an operational efficiency curve of the network with second smaller (next to the smallest) number of windings in the stator coil L2 of FIG. 7A.

FIG. 8A is a schematic view of the second embodiment in the present invention, wherein three Y type coils are switched to a stator coil L3 with a third smaller number of windings by switches.

FIG. 8B is an operational efficiency curve of the network with third smaller number of windings in the stator coil L3 of FIG. 8A.

FIG. 9A is a schematic view of the second embodiment in the present invention, wherein three Y type coils are switched to a stator coil L1+L2 with a fourth smaller number of windings by switches.

FIG. 9B is an operational efficiency curve of the network with fourth smaller number of windings of the stator coil L1+L2 of FIG. 9A.

FIG. 10A is a schematic view of the second embodiment in the present invention, wherein three Y type coils are switched to a stator coil L1+L2 with a fifth smaller number of windings by switches.

FIG. 10B is an operational efficiency curve of the network with fifth smaller number of windings of the stator coil L1+L3 of FIG. 10A.

FIG. 11A is a schematic view of the second embodiment in the present invention, wherein three Y type coils are switched to a stator coil L2+L3 with a sixth smaller number of windings by switches.

FIG. 11B is an operational efficiency curve of the network with sixth smaller number of windings of the stator coil L2+L2 of FIG. 11A.

FIG. 12A is a schematic view of the second embodiment in the present invention, wherein three Y type coils are switched to a stator coil L1+L2+L3 with a seventh smaller number of windings by switches.

FIG. 12B is an operational efficiency curve of the network with seventh smaller number of windings of the stator coil L1+L2+L3 of FIG. 12A.

FIGS. 13A and 13B shows the operation efficiency curve in the second embodiment of the present invention, wherein seven twisting force constant KT are combined so as to have a wider operation range.

FIGS. 14A to 14C are schematic views of the conventional Y type, Δ type and single phases coils.

FIG. 14D shows the operation efficiency curves of the stator coils L1 in FIG. 14A to 14C.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

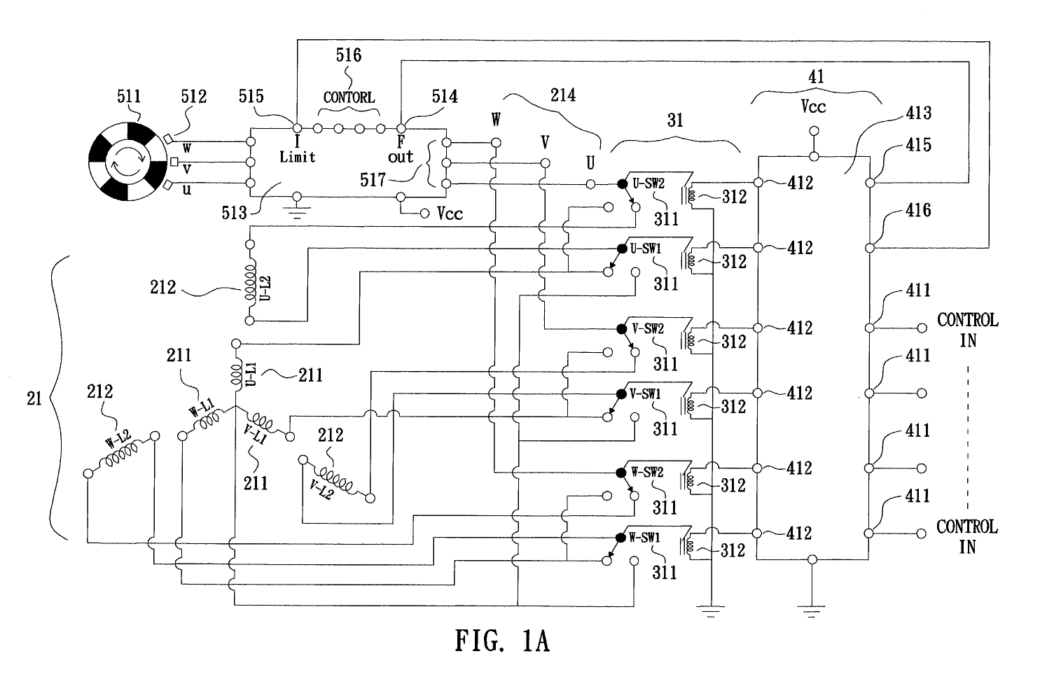

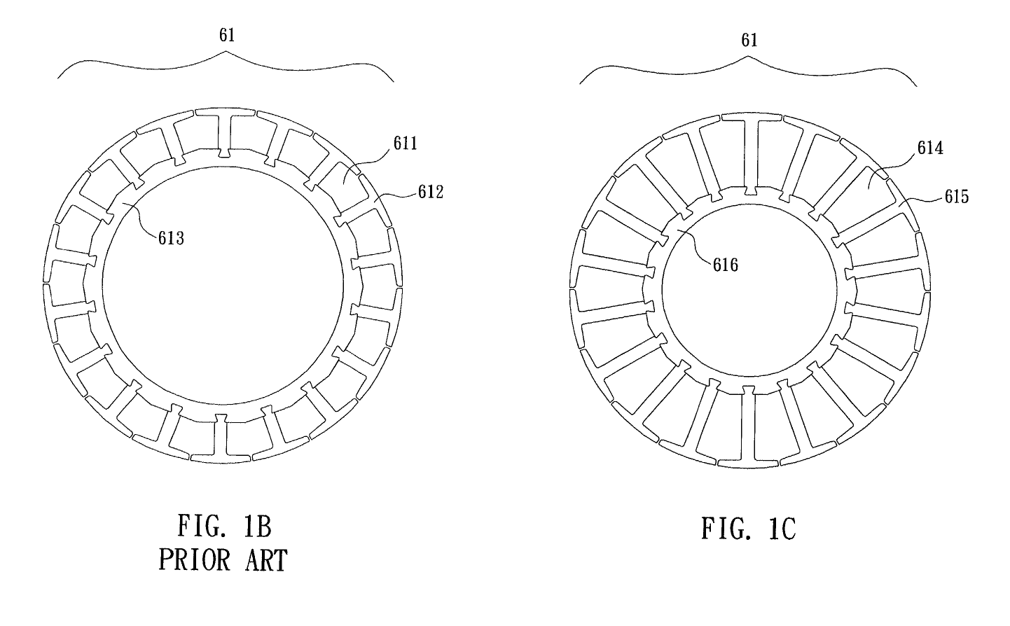

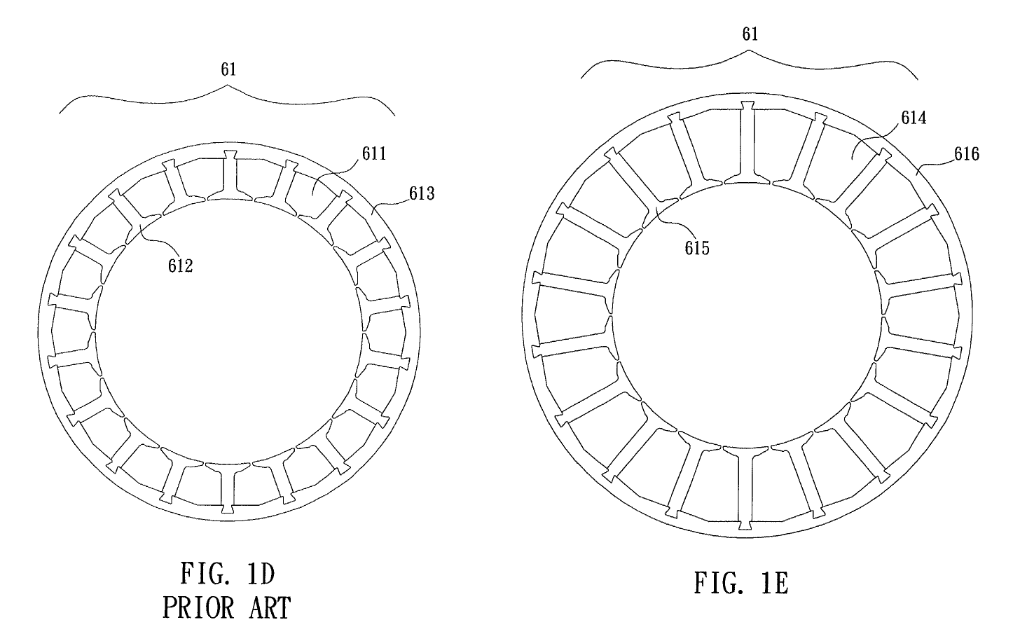

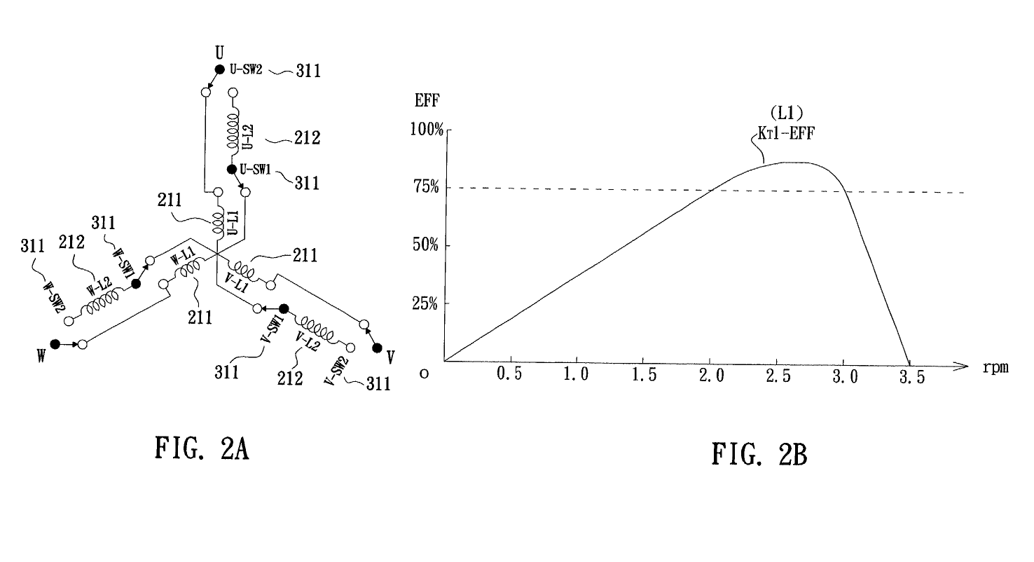

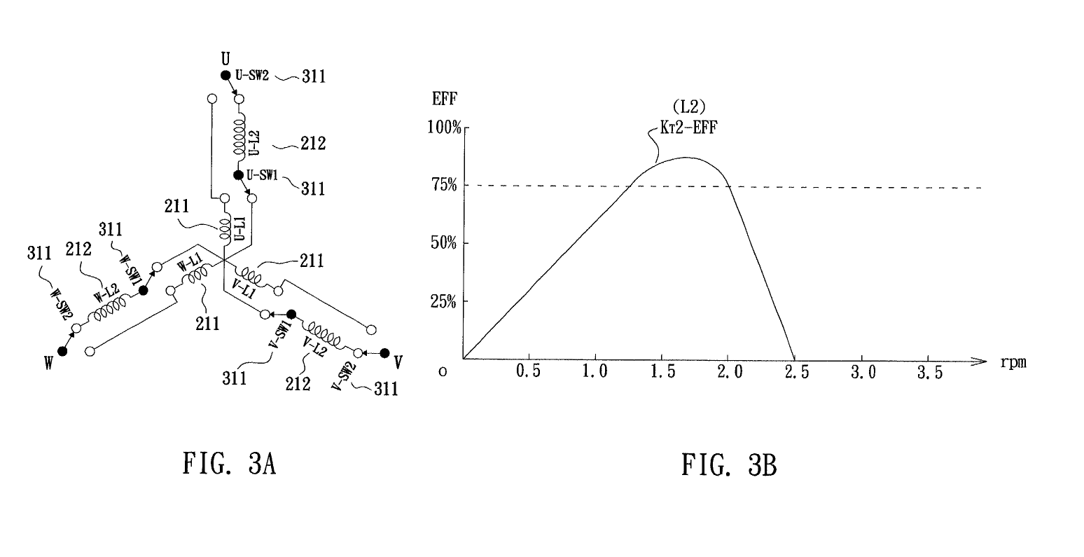

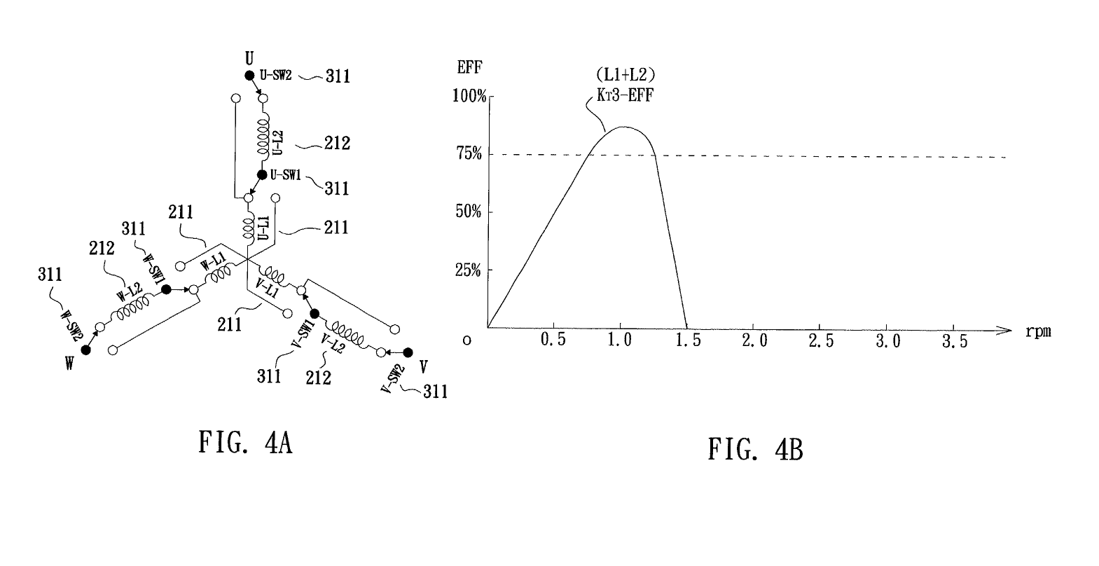

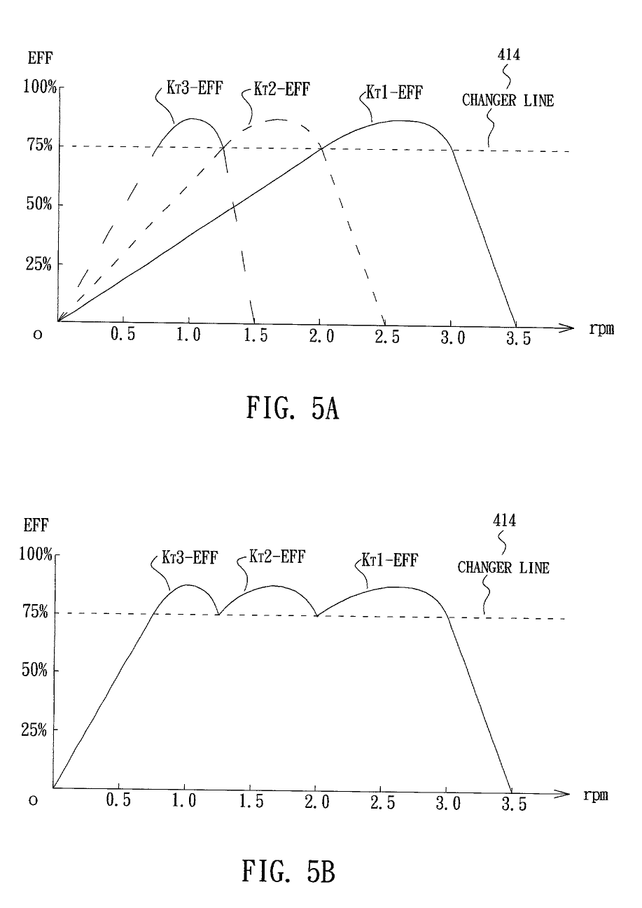

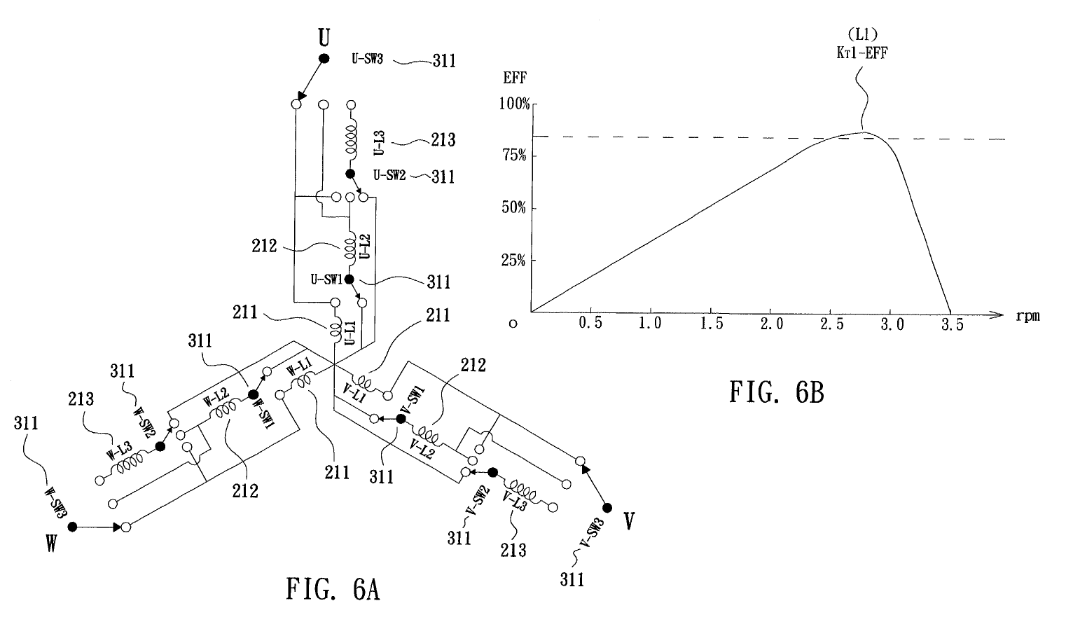

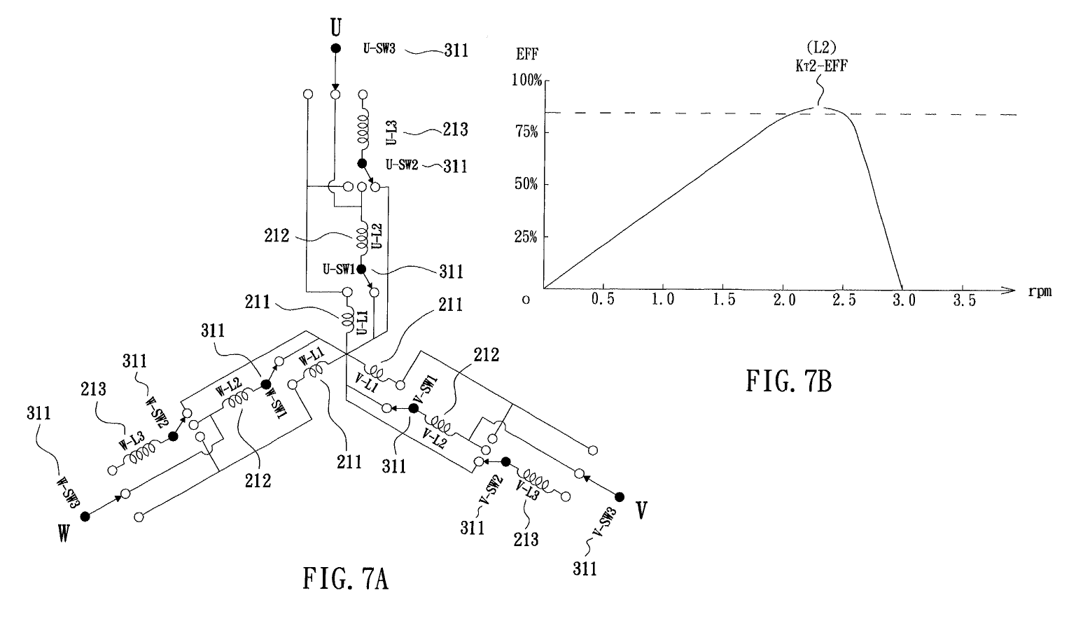

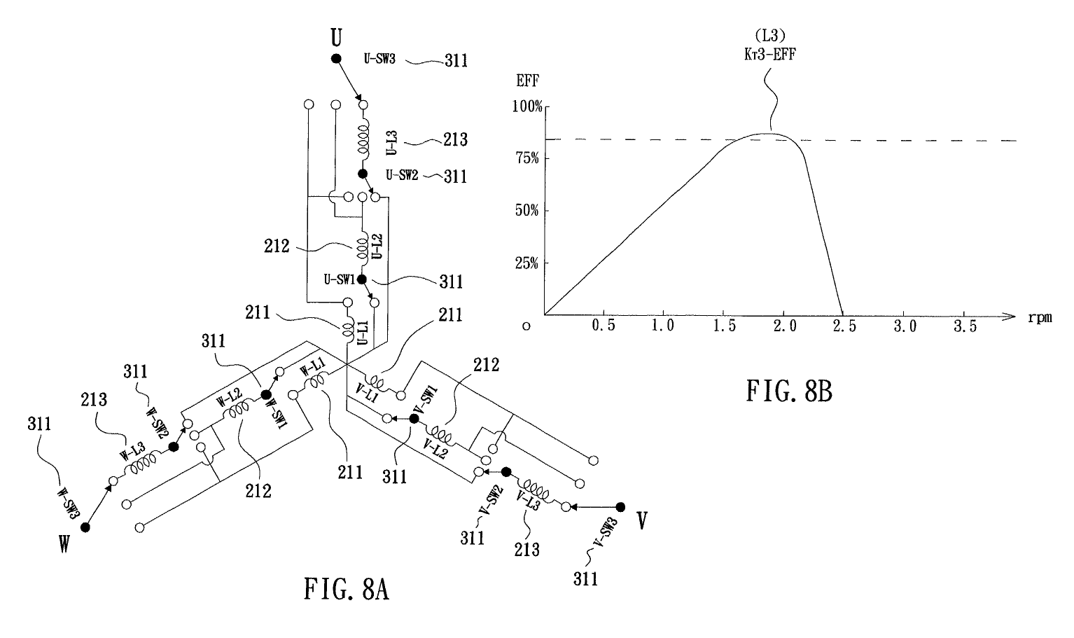

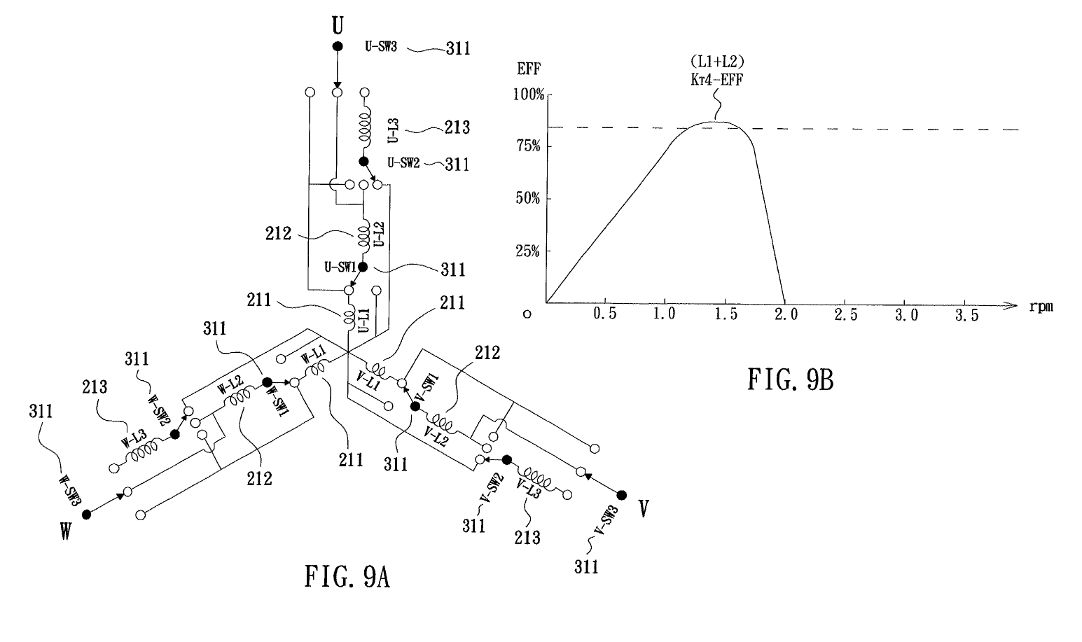

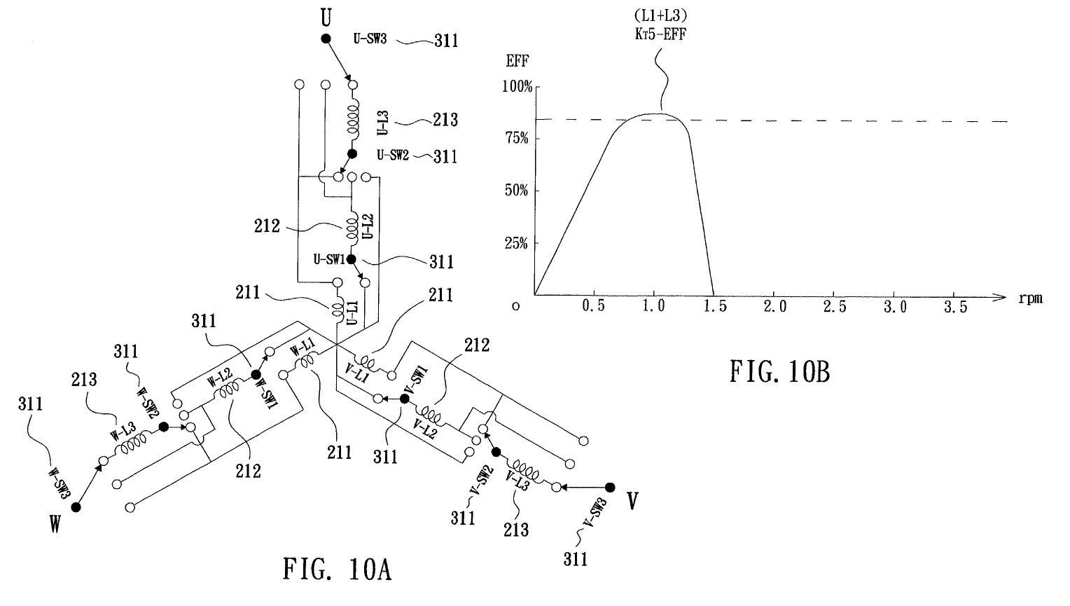

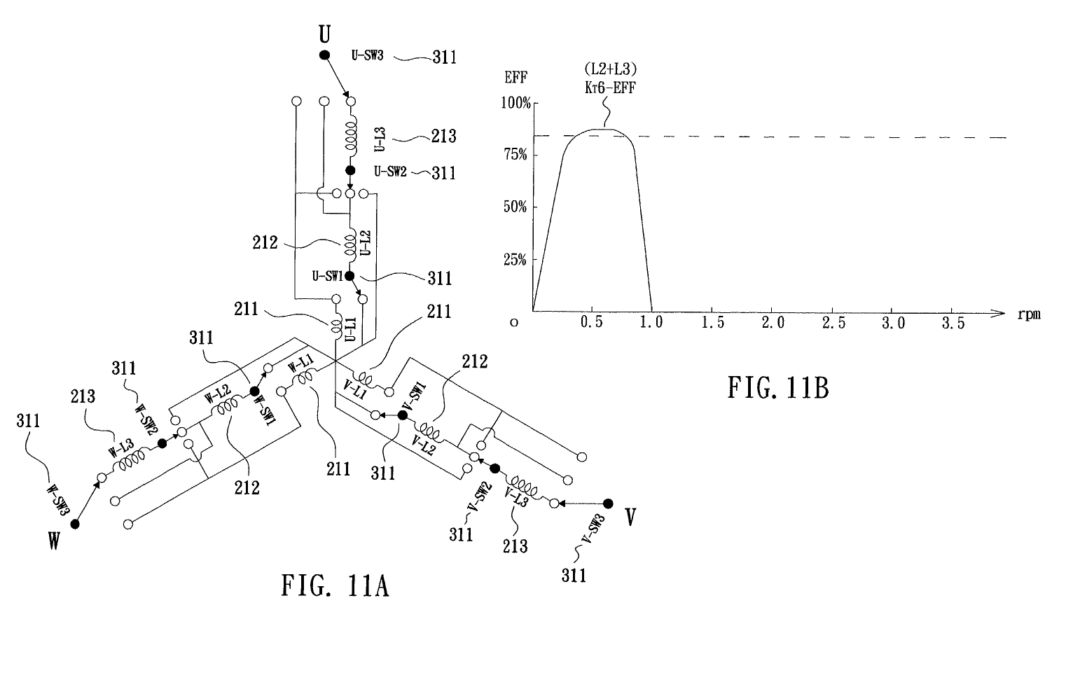

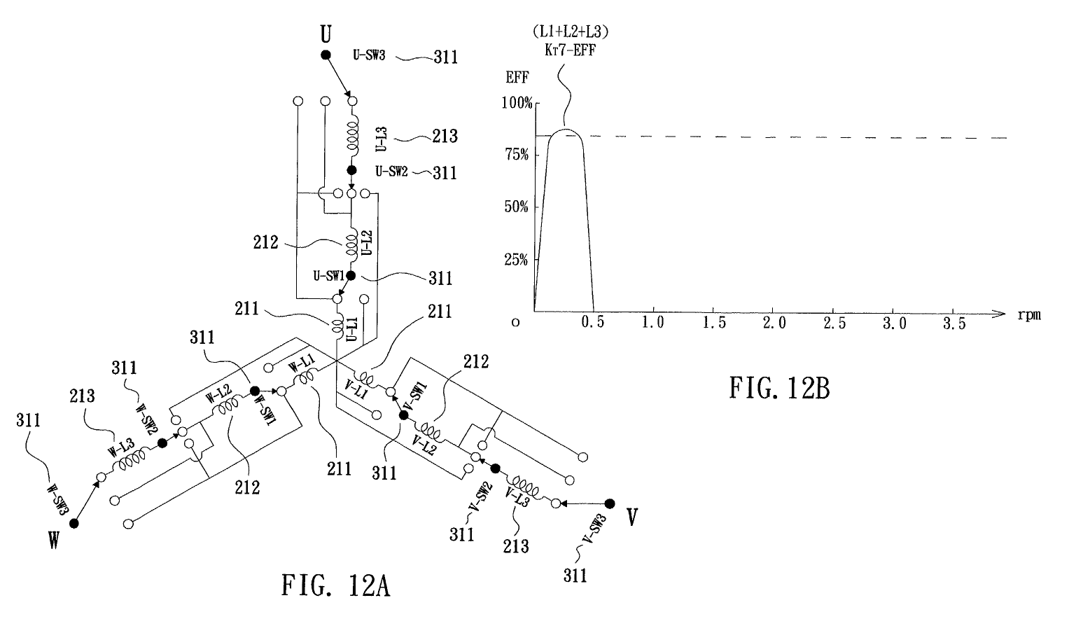

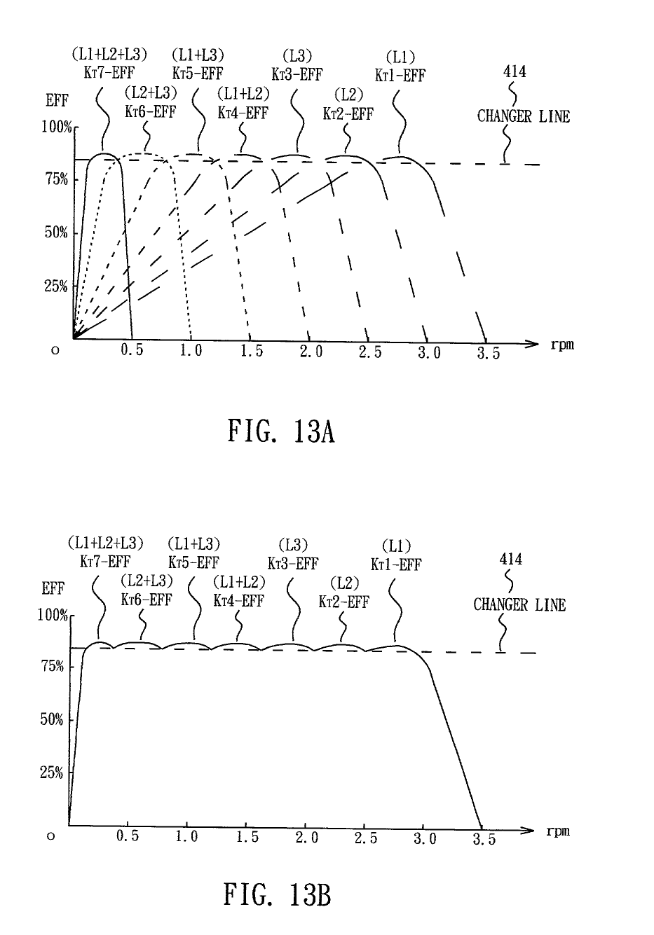

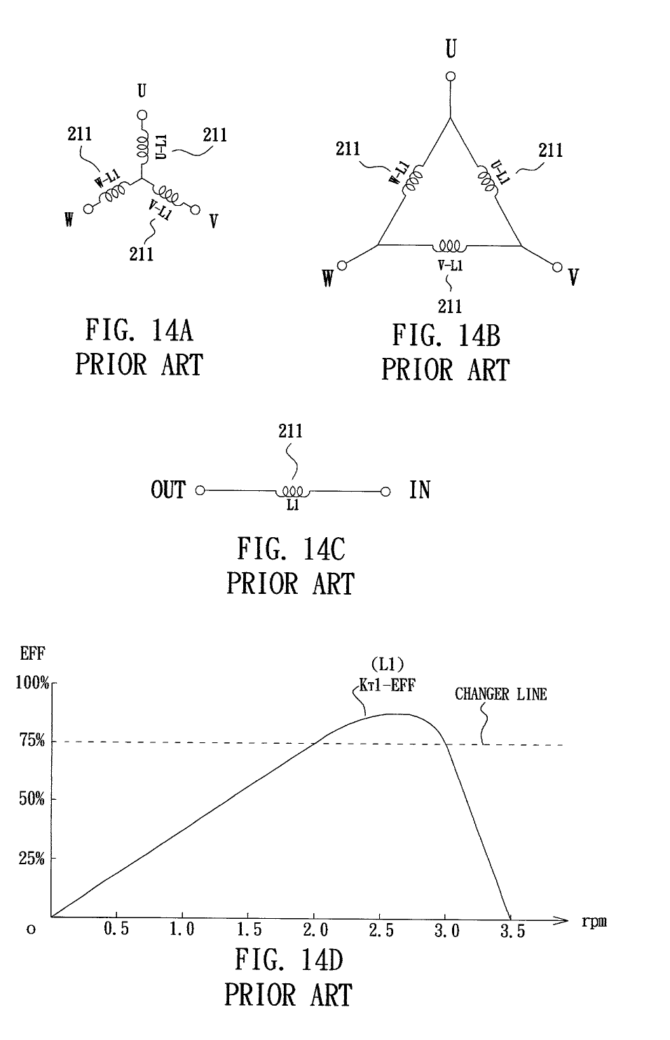

Referring to FIGS. 1A, 1C and 1E to 13A and 13B. The electromotive machine 10 of the present invention is illustrated, which is especially a stator device used in the electromotive machines or generators. It includes the following components.

A stator portion 61 is provided to various stator coils 21 of single phases or three phases to be installed in stator grooves 614. The stator groove 614 has a proper larger space for receiving the stator coil windings with more winding number.

A plurality of stator coils 21 includes a plurality of stator coils 211, 212, and 213 with various numbers of windings. The coils are overlapped or adjacent arranged to be placed in the same stator portion 61, each of the coils 211, 212, and 213 being opened to other coil, and each of a wire head and wire tail of each of the stator coils 211, 212, and 213 being connected to a switches 31 so as to be formed with a Y type three phases connection 214.

A plurality of switches 31 each having an input end 312 controlled by the management control unit 413 of the control system 41 through the output point 412. The control joints 311 of the plurality of switches 31 are connected to the wire heads and wire tails of the stator coils 211, 212, and 213.

A control system 41 having a management control unit 413 therein sets the switching forms of switches. The management control unit 413 manages all the switching forms of the switches 31. After switching the switches 31, the coils 211, 212, and 213 of the stator portion 61 can be connected in series to be formed with different connections or selectively switching to any one of the coils 211, 212, and 213 so as to be formed with various networks of the coils with different numbers of windings. A coil winding network with various numbers of windings is formed in the stator portion 61 through the control of the management control unit 413 of the control system 41, i.e., in the network, various inverse electromotive force K_{E} and twisting force constant K_{T}, as that disclosed in FIG. 1A, wherein an operation rotary speed device 511, a rotary speed sensor 512, a three phases coil controller 514, rotary speed detecting points 514, a current sensor 515 and control joints 516 are included.

Each of the coils 211, 212, and 213 may have the same or different numbers of windings. Through the management control unit 413 of the control system 41, the switches 31 can be switched to one of the coils 211, 212, and 213 or the plurality of coils 211, 212, and 213 can be partially or wholly connected in series to be formed as a winding network. The number of windings can be varied in any forms. The inverse electromotive force K_{E} and twisting force constant K_{T} may be varied in different ways.

The change of the management control unit 413 of the control system 41 is simulated by the inverse electromotive force K_{E} and twisting force constant K_{T} in advance to calculate various preferred operation area. Furthermore, the operation speed rmp value in a preferred operation area is used as a reference. The rotary speed sensor 512 is used to detect operation rotary speed signals (415) which is inputted to the control system 41 for being switched by the switches 31 as to change order.

The change of the management control unit 413 of the control system 41 is simulated by the inverse electromotive force K_{E} and twisting force constant K_{T} in advance to calculate various preferred operation area. Furthermore, the operation current value in a preferred operation area is used as a reference. The rotary speed sensor 512 is used to detect operation current signals 416 which is inputted to the control system 41 for being switched by the switches 31 as to change order.

The change of the management control unit 413 of the control system 41 is controlled manually. In this process, control signals are manually inputted through the control signal input 411 to the control system 41. The management control unit 413 of the control system 41 causes a switch signal output 412 to output the form of the input signal according to the form of the input signal from the control signal input 411 so that the switches 31 are switched to a winding network with respect to require number of windings.

The numbers of windings of the coils 211, 212, and 213 in the stator portion 61, inverse electromotive force K_{E}, twisting force constant K_{T} can be varied in various forms. Therefore, in the lower, middle and high operation speed ranges of an electromotive machine or generators, the operational efficiencies in the whole area can be improved uniformly, thereby having a high EFF value.

The numbers of windings of the coils 211, 212, and 213 in the stator portion 61 may be varied in various forms, and thus the electromotive machine causes the numbers of windings of the coils 211, 212, and 213, twisting force constant K_{T} and inverse electromotive force K_{E} can be varied in low and middle operational speed with respect to the requirement of the output twisting force of the electromotive machine. Therefore, the output twisting force of the electromotive machine can be improved properly.

The numbers of windings, wire diameters, and winding ways of the coils 211, 212, and 213 can be changed with the change of the manufacturing method.

The switch 31 is a relay with joints for switching the coils 211, 212, and 213 of the stator portion 61.

The switch 31 is a jointless semiconductor device for switching the coils 211, 212, and 213 of the stator portion 61.

The coils 211, 212, and 213 has a three phases Y coil winding type for being changed and managed by the control system 41.

The coils 211, 212, and 213 has a single phases Δ coil winding type for being changed and managed by the control system 41.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A high performance stator device comprising:
a stator portion being provided to various stator coils to be installed in stator grooves; wherein the stator groove having a proper larger space for receiving windings of stator coil with more winding numbers;
a plurality of stator coils including a plurality of stator coils with various numbers of windings; the coils being overlapped or adjacent arranged to be placed in the same stator portion, each of the coils being opened to other coil; each of a wire head and wire tail of each of the stator coils being connected to a switches so as to be formed with a Y type three phases connection.
a plurality of switches each having an input end controlled by a management control unit of a control system through the output point; the control joints of the plurality of switches being connected to the wire heads and wire tails of the stator coils; and
the control system having a management control unit therein which sets the switching forms of switches; the management control unit managing all the switching forms of the switches; after switching the switches, the coils of the stator portion being connected in series to be formed with different connections or selectively switching to any one of the coils so as to be formed with various networks of the coils with different numbers of windings; a coil winding network with various numbers of windings being formed in the stator portion through the control of the management control unit of the control system, i.e., in the network, various inverse electromotive force K_{E} and twisting force constant K_{T}.

2. The high performance stator device as claimed in claim 1, wherein there are at least three coils, and each of the coils have the same or different numbers of windings; through management control unit of the control system, the switches are switched to one of the coils or the plurality of coils are partially or wholly connected in series to be formed as a winding network; numbers of windings are varied in any forms; the inverse electromotive force K_{E} and twisting force constant K_{T} are varied in different ways.

3. The high performance stator device as claimed in claim 1, wherein there are at least two coils, and each of the coils have the same or different numbers of windings; through management control unit of the control system, the switches are switched to one of the coils or the plurality of coils are partially or wholly connected in series to be formed as a winding network; numbers of windings are varied in any forms; the inverse electromotive force K_{E} and twisting force constant K_{T} are varied in different ways.

4. The high performance stator device as claimed in claim 1, wherein change of the management control unit of the control system is simulated by the inverse electromotive force K_{E} and twisting force constant K_{T} in advance to calculate various preferred operation area; an operation speed rmp value in a preferred operation area being used as a reference; the rotary speed sensor is used to detect operation rotary speed signals which are inputted to the control system for being switched by the switches as to change orders.

5. The high performance stator device as claimed in claim 1, wherein change of the management control unit of the control system is simulated by the inverse electromotive force KE and twisting force constant KT in advance to calculate various preferred operation area; an operation current value in a preferred operation area is used as a reference; a rotary speed sensor is used to detect operation current signals which is inputted to the control system for being switched by the switches as to change orders.

6. The high performance stator device as claimed in claim 1, wherein change of the management control unit of the control system is controlled manually; in this process, control signals are manually inputted through the control signal input end to the control system; the management control unit of the control system cause a switch signal output end to output the form of the input signal according to the form of the input signal from the control signal input end so that the switches are switched to a winding network with respect to require number of windings.

7. The high performance stator device as claimed in claim 1, wherein numbers of windings of the coils in the stator portion, inverse electromotive force K_{E}, twisting force constant K_{T} can be varied in various forms, thereby, in the lower, middle and high operation speed ranges of an electromotive machine or generators, the operational efficiencies in the whole areas are improved uniformly, thereby having a high EFF value.

8. The high performance stator device as claimed in claim 1, wherein numbers of windings of the coils in the stator portion are varied in various forms, and thus the electromotive machine causes the numbers of windings of the coils, twisting force constant K_{T} and inverse electromotive force K_{E} are be various in low and middle operational speed with respect to the requirement of the output twisting force of the electromotive machine; therefore, an output twisting force of the electromotive machine is improved properly.

9. The high performance stator device as claimed in claim 1, wherein numbers of windings, wire diameters, and winding ways of the stator coils are changed with changes of manufacturing methods.

10. The high performance stator device as claimed in claim 1, wherein the switch is a relay with joints for switching the coils of the stator portion.

11. The high performance stator device as claimed in claim 1, wherein the switch is a jointless semiconductor device for switching the coils of the stator portion.

12. The high performance stator device as claimed in claim 1, wherein the stator coils has a three phases Y coil winding type for being changed and managed by the control system.

13. The high performance stator device as claimed in claim 1, wherein the stator coils has a three phases Δ coil winding type for being changed and managed by the control system.

14. The high performance stator device as claimed in claim 1, wherein the stator coils has a single phases coil winding type for being changed and managed by the control system.
